(19) United States
(12) Patent Application Publication
(10) Pub. No.: US 2025/0071864 A1
(43) Pub. Date: Feb. 27, 2025

(54) SYSTEMS AND METHODS FOR INDUCTION COOKING WITH SUPPLEMENTAL BATTERY

(71) Applicant: Haier US Appliance Solutions, Inc., Wilmington, DE (US)

(72) Inventors: Ali Faraji-Tajrishi, Louisville, KY (US); Nathaniel Lehrer, Louisville, KY (US); Jonah Connelly, Louisville, KY (US)

(21) Appl. No.: 18/454,422

(22) Filed: Aug. 23, 2023

(51) Int. Cl. H05B 6/06; H05B 6/04

(52) U.S. Cl. CPC H05B 6/06; H05B 6/04; H05B 1/0266; H05B 2206/02

(57) ABSTRACT

A cooktop appliance is provided. The cooktop appliance includes an induction heating system having an induction heating element, a power supply circuit, a battery assembly, and a controller. The induction heating element is operable to inductively heat a load with a magnetic field. The power supply circuit includes an inverter and is coupled to an alternating current (AC) power supply configured to supply a power signal to the induction heating system. The battery assembly is coupled to the power supply circuit via a switching element and is configured to provide a supplemental power signal to the induction heating system. The controller is operably coupled to the power supply circuit and the battery assembly and is configured to control operation of the induction heating system based, in part, on a power requirement of the induction heating system that corresponds to a total power output required by the induction heating system.

### FIELD

Example aspects of the present disclosure generally relate to induction cooktop appliances and, more particularly, to induction cooktop appliances with a supplemental battery assembly.

### BACKGROUND

Induction cooking appliances are more efficient, have greater temperature control precision and provide more uniform cooking than other conventional cooking appliances. In conventional cooktop systems, an electric or gas heat source is used to heat cookware in contact with the heat source. This type of cooking is inefficient because only the portion of the cookware in contact with the heat source is directly heated. The rest of the cookware is heated through conduction that causes non-uniform cooking throughout the cookware. Heating through conduction takes an extended period of time to reach a desired temperature.

In contrast, induction cooking systems use electromagnetism which turns cookware of the appropriate material into a heat source. Such appropriate materials may include ferromagnetic materials in order to effectively capture the magnetic field produced by the induction cooking coil. Other materials, such as aluminum, will be very inefficient for cooking on an induction cooking system. A power supply provides a signal having a frequency to the induction coil. When the coil is activated a magnetic field is produced which induces a current on the bottom surface of the cookware. The induced current on the bottom surface then induces even smaller currents (Eddy currents) within the cookware thereby providing heat throughout the cookware.

### SUMMARY

Aspects and advantages of embodiments of the present disclosure will be set forth in part in the following description, or can be learned from the description, or can be learned through practice of the embodiments.

One example aspect of the present disclosure is directed to a cooktop appliance. The cooktop appliance may include a user interface having a user input. The cooktop appliance may further include an induction heating system. The induction heating system may include an induction heating element operable to inductively heat a load with a magnetic field. The induction heating system may further include a power supply circuit coupled to an alternating current (AC) power supply configured to supply a power signal to the induction heating system. The power supply circuit may include an inverter. The cooktop appliance may further include a battery assembly coupled to the power supply circuit via a switching element. The battery assembly may be configured to provide a supplemental power signal to the induction heating system. The cooktop appliance may further include a controller operably coupled to the power supply circuit and to the battery assembly. The controller may be configured to control operation of the induction heating system based at least in part on a power requirement of the induction heating system. The power requirement may correspond to a total power output required by the induction heating element.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a perspective view of an example induction cooktop appliance according to example embodiments of the present disclosure;

FIG. 2A depicts a block diagram of an example induction heating system according to example embodiments of the present disclosure;

FIG. 2B depicts a circuit schematic of the example induction heating system of FIG. 2A according to example embodiments of the present disclosure;

FIG. 3A depicts an example battery assembly of the example induction heating system of FIGS. 2A-2B according to example embodiments of the present disclosure;

FIG. 3B depicts an example battery assembly of the example induction heating system of FIGS. 2A-2B according to example embodiments of the present disclosure;

FIG. 4 depicts a graphical representation of example power signals supplied to an inverter of the induction heating system of FIGS. 2A-2B according to example embodiments of the present disclosure;

FIG. 5 depicts a flow diagram of an example method for operating a cooktop appliance according to example embodiments of the present disclosure;

FIG. 6A depicts a block diagram of the example induction heating system of FIG. 2A according to example embodiments of the present disclosure;

FIG. 6B depicts a block diagram of the example induction heating system of FIG. 2A according to example embodiments of the present disclosure;

FIG. 7A depicts a block diagram of the example induction heating system of FIG. 2A according to example embodiments of the present disclosure;

FIG. 7B depicts a block diagram of the example induction heating system of FIG. 2A according to example embodiments of the present disclosure; and

FIG. 8 depicts a block diagram of the example induction heating system of FIG. 2A according to example embodiments of the present disclosure.

Repeat use of reference characters in the present specification and drawings is intended to represent the same and/or analogous features or elements of the present invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure generally relate to induction cooktop appliances. In particular, example aspects of the present disclosure provide an induction cooktop appliance having an induction heating element (e.g., induction coil) operable to inductively heat a load with a magnetic field. The induction cooktop appliance may further include a power supply circuit coupled to an alternating current (AC) power supply configured to provide a power signal to the induction heating element.

Conventional induction cooktop appliances are typically powered by standard 40 A (Amperes), 240 VAC (Volts Alternating Current) power supplies. In contrast, other conventional cooktop appliances (e.g., gas-powered cooktops) are typically powered by standard 15 A, 120 VAC power supplies. As used herein, “high power circuit” refers to a circuit powered by a standard 240 VAC power supply. Similarly, “low power circuit” refers to a circuit powered by a standard 120 VAC power supply.

Recent market trends indicate consumers are increasingly switching from conventional cooktop appliances, such as gas-powered cooktops, to induction cooktop appliances. However, as noted above, gas-powered cooktops traditionally run off low power circuits, while induction cooktop appliances primarily run off high power circuits. Thus, consumers are forced to incur considerable costs in order to switch to cooktop appliances that run off high power circuits. More particularly, many consumers are forced to, for instance, re-wire their homes and update their electrical panel to account for the increased power supply necessary to support traditional cooktops that run off high power circuits. Thus, to avoid these unnecessary costs, an induction cooktop appliance run off a low power circuit that is capable of providing the same power output as a cooktop run off a high power circuit is desirable.

Accordingly, example aspects of the present disclosure provide an induction cooktop appliance that is able to supply the same power output on a low power circuit (e.g., a 15 A, 120 VAC power supply) that is normally provided by a high power circuit (e.g., a 30 A, 240 VAC power supply). More particularly, example aspects of the present disclosure provide an induction cooktop appliance having a user interface and an induction heating system. The induction heating system may include a power supply circuit that is fed by a 120 VAC power supply. The power supply circuit may include, inter alia, a rectifier circuit coupled between an inverter and the AC power supply. The AC power supply, via the inverter, may be configured to provide a power signal to an induction heating element, such as an induction coil, to inductively heat a load (e.g., a cooking vessel) with a magnetic field.

The induction cooktop appliance according to the present disclosure may further include a battery assembly coupled in series with the power supply circuit. The battery assembly may be coupled to the power supply circuit via a switching element, such as a double-pole double-throw switch and/or a relay. As will be discussed in greater detail below, the battery assembly may provide additional power to the inverter in situations where the AC power supply is incapable of providing enough power as required by the induction heating element. In this manner, the battery assembly may operate as a supplemental power source to the induction cooktop appliance. Conversely, when additional power is not required, the battery assembly may recharge by receiving charge from the power supply circuit. Furthermore, in situations where the induction cooktop appliance is disconnected from the AC power source (e.g., a power outage), the battery assembly, alone, may provide power to the inverter.

Furthermore, the induction cooktop appliance according to the present disclosure may also include a controller operably coupled to the power supply circuit and the battery assembly. In this way, the controller may be configured to control operation of the induction heating system based at least in part on the power requirement of the induction heating system. The battery assembly may include one or more battery packs, each of which having a plurality of battery cells. The battery assembly may further include a battery manager coupled to the one or more battery packs and the controller. As such, the battery manager may be configured to operate the battery assembly based at least in part on one or more control signals received from the controller.

Furthermore, in some embodiments, the battery assembly may further include a bidirectional voltage converter, such as a direct current to direct current (DC-DC) converter coupled to the battery manager and the controller. The bidirectional voltage converter may be configured to charge each of the one or more battery packs of the battery assembly. Furthermore, the bidirectional voltage converter may be configured to provide the supplemental power signal to the inverter of the power supply circuit and may also be configured to adjust a total output voltage of the supplemental power signal.

As noted above, the controller of the induction cooktop appliance according to example embodiments of the present disclosure may be configured to control operation of the induction heating system based at least in part on the power requirement of the induction heating system. More particularly, the controller may be configured to control operation of the induction heating system by performing operations that include, e.g., receiving a power request for the inverter and determining whether the power request exceeds a mains power threshold. As discussed in greater detail below, the controller may receive the power request corresponding to the power requirement, which corresponds to a total power output required by the induction heating element. Furthermore, the mains power threshold indicates a maximum power suppliable by the AC power supply.

Furthermore, the controller may be configured to adjust one or more operating parameters of the battery assembly in response to determining whether the power request exceeds the mains power threshold. More particularly, in response to determining the mains power threshold exceeds the power request, the controller may configure the battery assembly to receive charge from the power supply circuit. In this manner, the battery assembly is able to be charged in situations where additional power is not required.

Conversely, in response to determining the power request exceeds the mains power threshold, the controller may configure the battery assembly to supply the supplemental power signal to the inverter which, in turn, may supply a combined power signal to the induction heating element. The combined power signal may include the power signal supplied by the AC power source, as well as the supplemental power signal supplied by the battery assembly. Furthermore, in some embodiments, the magnitude of the supplemental power signal corresponds to a difference between the power request and the mains power threshold (e.g., a power deficit of the induction heating system). As such, the battery assembly is operable as a supplemental power supply in situations where the AC power supply is incapable of supplying sufficient power to the inverter. In this manner, an induction cooktop appliance according to the present disclosure may achieve the same power output as a cooktop having a high power AC power supply.

Example aspects of the present disclosure provide numerous technical effects and benefits. For instance, by providing a battery assembly in series with a power supply circuit, an induction cooktop appliance of the present disclosure is capable of providing the same power output as cooktops fed off high power circuits while being fed by a low power circuit. In this way, example aspects of the present disclosure provide significant cost reductions for consumers who decide to switch from, e.g., a gas-powered cooktop appliance to an induction cooktop appliance. For instance, the present disclosure provides an induction cooktop appliance that may be installed without updating a pre-existing electrical panel and/or electrical wiring. Furthermore, an example induction cooktop appliance may maintain a power factor close to one, which limits peaks associated with the current pulled from the AC power supply. In this manner, example aspects of the present disclosure do not require higher current-rated components to make up for the lower power supply, while, at the same time, achieving the same power output as a cooktop running off a high power AC power supply. Furthermore, example aspects of the present disclosure do not require significant changes to inverters that already run on high power circuit (e.g., a 240 VAC power supply). Moreover, example aspects of the present disclosure provide improvements to minimum power levels on the induction cooktop appliance. More particularly, example aspects of the present disclosure provide an additional lever to adjust the minimum power on induction cooktop appliances to avoid turning the induction heating element on and off to achieve lower power levels.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (e.g., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

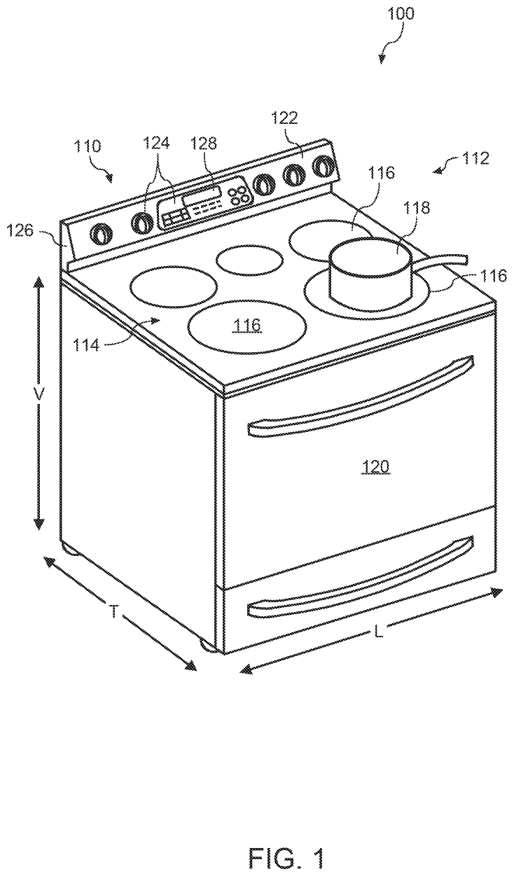

FIG. 1 depicts a perspective view of an induction cooktop appliance 100. The induction cooktop appliance includes a range 110. The range 110 includes a cooktop 112, such as an induction cooktop. Range 110 is provided by way of example only and is not intended to limit the present subject matter to the arrangement shown in FIG. 1. Thus, the present subject matter may be used with other range 110 and/or cooktop 112 configurations, e.g., double oven range appliances, standalone cooktop appliances, cooktop appliances without an oven, etc.

A cooking surface 114 of cooktop appliance 112 includes a plurality of heating elements 116. The heating elements 116 are generally positioned at, e.g., on or proximate to, the cooking surface 114. In certain exemplary embodiments, cooktop 112 may be an induction cooktop with induction heating elements mounted below cooking surface 114. For the embodiment depicted, the cooktop 112 includes five heating elements 116 spaced along cooking surface 114. However, in other embodiments, the cooktop appliance 112 may include any other suitable shape, configuration, and/or number of heating elements 116. Each of the heating elements 116 may be the same type of heating element 116, or cooktop appliance 112 may include a combination of different types of heating elements 116. For example, in various embodiments, the cooktop appliance 112 may include any other suitable type of heating element 116 in addition to the induction heating element, such as a resistive heating element or gas burners, etc.

As shown in FIG. 1, a cooking utensil 118, such as a pot, pan, or the like, may be placed on a heating element 116 to heat the cooking utensil 118 and cook or heat food items placed in cooking utensil 118. Range appliance 110 also includes a door 120 that permits access to a cooking chamber (not shown) of range appliance 110, e.g., for cooking or baking of food items therein. A control panel 122 having controls 124 permits a user to make selections for cooking of food items. Although shown on a backsplash or back panel 126 of range appliance 110, control panel 122 may be positioned in any suitable location. Controls 124 may include buttons, knobs, and the like, as well as combinations thereof, and/or controls 124 may be implemented on a remote user interface device such as a smartphone, tablet, etc. As an example, a user may manipulate one or more controls 124 to select a temperature and/or a heat or power output for each heating element 116. The selected temperature or heat output of heating element 16 affects the heat transferred to cooking utensil 118 placed on heating element 116. The control panel 122 may also include a display 128.

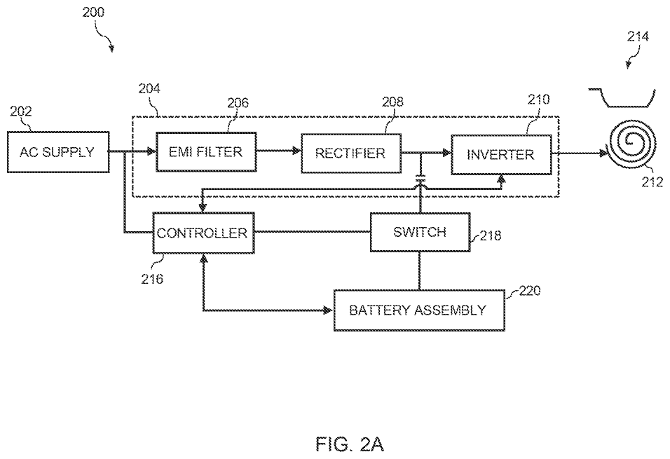

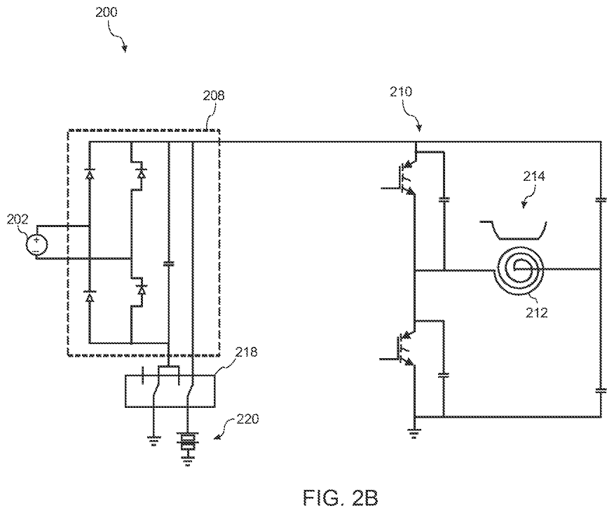

The cooktop appliance 100 includes a control system for controlling one or more of the plurality of heating elements 116. Specifically, the control system may include a controller operably connected to the control panel 122 and the controls 124 and display 128 thereof. The controller may be operably connected to each of the plurality of heating elements 116 for controlling a heating level each of the plurality of heating elements 116 in response to one or more user inputs received through the control panel 122 and controls 124. The controller may also provide output to the display 128, such as an indication of a selected power level, which heating element(s) 116 is or are activated, etc. Furthermore, as will be discussed in greater detail below, the controller may further be configured to control operation of an induction heating system 200 (FIGS. 2A-2B) of the cooktop appliance 100 based at least in part on one or more electrical characteristics associated with the induction heating system 200.

FIGS. 2A-2B depict an example induction heating system 200 according to one embodiment of the present disclosure. More particularly, FIG. 2A depicts a block diagram of an example induction heating system 200, and FIG. 2B depicts a circuit schematic of the example induction heating system depicted in FIG. 2A. The induction heating system 200 may be used in, for instance, the induction cooktop appliance 100 discussed above with reference to FIG. 1. As shown in FIGS. 2A-2B, the induction heating system 200 generally includes an alternating current (AC) power supply 202. In some embodiments, the AC power supply 202 may provide conventional 60 Hz 120 VAC supplied by utility companies. Additionally and/or alternatively, the AC power supply 202 may provide conventional 208 VAC, 220 VAC, and/or 240 VAC supplied by utility companies. As used herein, the “mains power threshold” of the induction heating system 200 refers to the maximum power level capable of being supplied by the AC power supply 202.

It should be noted that an induction cooktop appliance according to the present disclosure (e.g., induction cooktop appliance 100) may include one or more induction heating systems 200. Those having ordinary skill in the art, using the disclosures provided herein, will appreciate that an induction cooktop appliance according to the present disclosure may have any suitable number of induction heating systems 200 without deviating from the scope of the present disclosure. For instance, in some embodiments, the induction cooktop appliance 100 may include a single induction heating system 200. Additionally and/or alternatively, the induction cooktop appliance 100 may include multiple induction heating systems 200. In such embodiments, each of the multiple induction heating systems 200 may be configured to communicate with each of the other induction heating systems 200 individually and/or with the induction cooktop appliance 100 as a whole.

The induction heating system 200 may further include a power supply circuit 204 coupled to the AC power supply 202. In this way, the AC power supply 202 and the power supply circuit 204 may be configured to supply a power signal to the induction heating system 200. In some embodiments, the power supply circuit 204 may include an electromagnetic interference (EMI) filter 206 coupled to the AC power supply 202.

The power supply circuit 204 may further include a rectifier circuit 208 coupled to the AC power source 202. More particularly, the rectifier circuit 208 may be coupled to the EMI filter 206. The rectifier circuit 208 may rectify the AC power signal provided by the AC power supply 202. The rectifier circuit 208 may further include a filter and power factor correction circuitry to filter the rectified voltage signal.

The power supply circuit 204 may further include an inverter module 210. The rectifier circuit 208 may be coupled to the inverter module 210. In this way, the rectifier circuit 208 may be configured to provide a rectified power signal to the inverter module 210. Furthermore, the inverter module 210 may be configured to supply an alternating current to an induction coil 212. Accordingly, the inverter module 210 may also be termed a variable frequency inverter module. It should be understood that the induction heating system 200 is depicted as having a single coil 212 for purposes of illustration and discussion. The induction heating system 200 described herein may include any number of coils 212 without deviating from the scope of the present disclosure. For instance, in some embodiments, the inverter module 210 may be configured to supply an alternating current to a plurality of induction coils 212.

The coil 212, when supplied by the inverter module 210 with an alternating current, may inductively heat a load, such as cookware 214 or other objects placed on, over, or near the coil 212. It should be understood that use of the term “cookware” herein is merely exemplary, and that term will generally include any object of a suitable type that is capable of being heated by the coil 212. Furthermore, as used herein, the “power requirement” of the induction heating system 200 refers to a total power output required by the induction heating element (e.g., induction coil 212).

The frequency of the current supplied to the coil 212 by the inverter module 210 and, hence, the output power of the coil 212 may be controlled by controller 216. It should be noted that the controller 216 is omitted from FIG. 2B for ease of illustration. The controller 216 may control the switching frequency of the inverter module 210 and one or more switching devices (not shown) of the inverter module 210. The controller 216 may also be implemented as a microcontroller and/or gate driver to drive individual transistors or switching devices of the appliance 100 with pulse-width modulated signals.

As shown, the controller 216 may be operably coupled to the power supply circuit 204. More particularly, the controller 216 may be operably coupled to the inverter 210 of the power supply circuit 204. Furthermore, the controller 216 may also be operably coupled to a battery assembly 220. As will be discussed in greater detail below, the controller 216 may be configured to control operation of the induction heating system 200 based at least in part on the power requirement of the induction heating system 200.

As shown, the battery assembly 220 may be coupled in series with the power supply circuit 204 via a switching element 218. It should be understood that any suitable switching element, such as a switch or a relay, may be used without deviating from the scope of the present disclosure. As will be discussed in greater detail below, the battery assembly 220 may be configured to supply a supplemental power signal to the induction heating system 200.

It should be noted that the arrangement of the rectifier 208, the inverter module 210, and the switching element 218 in FIG. 2B is for purposes of illustration and effect. Those having ordinary skill in the art, using the disclosures provided herein, will appreciate that any suitable topology may be used without deviating from the scope of the present disclosure.

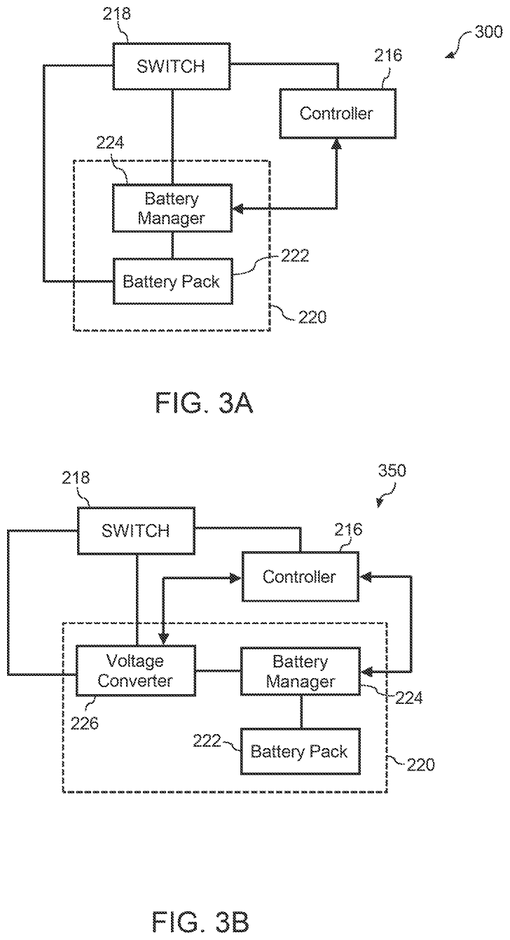

Referring briefly to FIGS. 3A-3B, example battery assemblies 220 are provided according to example embodiments of the present disclosure. More particularly, FIG. 3A depicts battery assembly 220 with configuration 300, and FIG. 3B depicts battery assembly 220 with configuration 350. It should be understood that configurations 300, 350 are provided for purposes of illustration and discussion, and battery assembly 220 discussed above may have any suitable configuration without deviating from the scope of the present disclosure.

Referring now to FIG. 3A, as shown, the battery assembly 220 of the induction heating system 200 (having configuration 300) may include one or more battery packs 222, and each battery pack 222 may include a plurality of battery cells (not shown). In some embodiments, the one or more battery packs 222 may be coupled in series. In other embodiments, the one or more battery packs 222 may be coupled in parallel. Furthermore, it should be noted that battery assembly 222 is depicted in FIG. 3A with only one battery pack 222 for purposes of illustration and discussion. Those having ordinary skill in the art, using the disclosures provided herein, will understand that the battery assembly 220 may include any number of battery packs 222 without deviating from the scope of the present disclosure. Furthermore, battery assembly 220 may further include a battery manager 224 coupled to the one or more battery packs 222. The battery manager 224 may also be coupled to the controller 216 of the induction heating system 200. In this way, the battery manager 224 may be configured to operate the battery assembly 220 based at least in part on control signals received from the controller 216. For instance, as will be discussed in greater detail below, the one or more battery packs 222 may be configured to provide a supplemental power signal having a fixed direct current (DC) component to the inverter 210 (FIGS. 2A-2B).

Referring now to FIG. 3B, as shown, the battery assembly 220 of the induction heating system 200 (having configuration 350) may also include the one or more battery packs 222 and the battery manager 224 discussed above with reference to FIG. 3A. However, in contrast to the battery assembly 220 of FIG. 3A, the battery assembly 220 of FIG. 3B further includes a bidirectional voltage converter 226. In some embodiments, the bidirectional voltage converter 226 may be a bidirectional DC to DC (DC-DC) converter. More particularly, as shown, the bidirectional voltage converter 226 may be coupled to the battery manager 224 and to the controller 216. As will be discussed in greater detail below, the bidirectional voltage converter 226 may be configured to adjust a total output voltage of the supplemental power signal by adjusting a DC voltage output of the one or more battery packs 222. More particularly, in some embodiments, the bidirectional voltage converter 226 may be configured to adjust the DC component of the supplemental power signal. Additionally, in situations where the power requirement of the induction heating system 100 is less than a minimum power output of the inverter 210, the bidirectional voltage converter 226 may be configured to adjust the total output voltage of the supplemental power signal to lower a total voltage input at the inverter 210. In this manner, the bidirectional voltage converter 226 may be configured to adjust the supplemental power signal provided to the inverter 210 (FIGS. 2A-2B). Furthermore, the bidirectional voltage converter 226 may be configured to provide charge to each of the one or more battery packs 222.

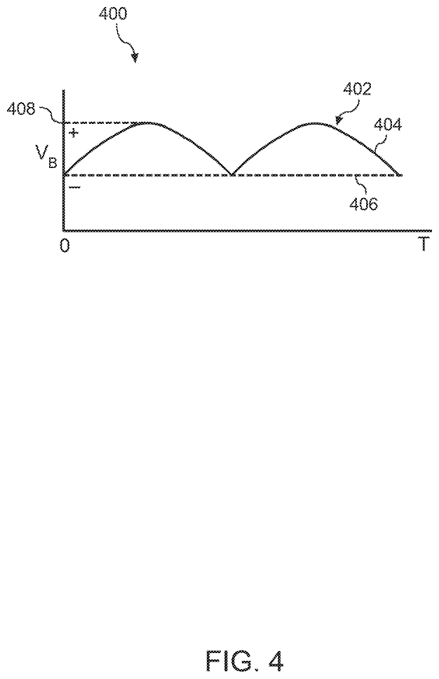

As an illustrative example, referring now to FIG. 4, a graphical representation (e.g., chart 400) of the power signals supplied to the inverter 210 (FIGS. 2A-2B) by the power supply circuit 204 (FIGS. 2A-2B) and the battery assembly 220 (FIGS. 2A-2B) is provided. As noted above, example aspects of the present disclosure provide an induction cooktop appliance fed by a low power circuit (e.g., 120 VAC power supply 202) that is capable of supplying a combined power signal equivalent to a similar cooktop appliance that is fed by a high power circuit (e.g., 240 VAC power supply). Chart 400 depicts voltage components (along a y-axis of chart 400) of a combined power signal 402 provided by the inverter 210 (FIGS. 2A-2B) to the coil 212 (FIGS. 2A-2B) as a function of time T (along an x-axis of chart 400).

As noted above, the combined power signal 402 may include an AC power signal 404. The AC power signal 404 may be provided to the inverter 210 (FIGS. 2A-2B) by the AC power supply 202 (FIGS. 2A-2B). It should be noted that, as depicted, power signal 404 is a rectified power signal. Thus, a power signal may be provided by the AC power supply 202 (FIGS. 2A-2B) to the rectifier circuit 208 (FIGS. 2A-2B), which, in turn, may provide the rectified AC power signal 404 to the inverter 210 (FIGS. 2A-2B). Furthermore, the combined power signal 402 may also include a DC power signal 406 (hereinafter “supplemental power signal 406”). As discussed herein, the battery assembly 220 may be configured to provide the supplemental power signal 406 to the inverter 210 (FIGS. 2A-2B) based at least in part on a power requirement 408 of the induction heating system 200. More particularly, the power requirement 408 of the induction heating system 200 may correspond to a total power output required by the coil 212 (FIGS. 2A-2B). Moreover, in embodiments (e.g., FIG. 3B), a magnitude of the power signal 406 may be adjusted by a bidirectional voltage converter 226 (FIG. 3B) of the battery assembly 220 (based on, e.g., control signals sent by the controller 216). In this way, the minimum power achievable by coil 212 may be controlled by, e.g., controller 216.

As shown in chart 400, the amplitude of power signal 404 would be insufficient to meet the power requirement 408 on its own. In other words, the AC power supply 202 (FIGS. 2A-2B) would be incapable of supplying the power requirement 408. As such, example aspects of the present disclosure provide an induction cooktop appliance that, in addition to the AC power supply 202 (FIGS. 2A-2B), also includes a battery assembly 220 (FIGS. 2A-2B) configured to provide the supplemental power signal 406. However, by stacking (e.g., combining) the power signal 404 and the supplemental power signal 406 at the inverter 210 (FIGS. 2A-2B), the inverter 210 (FIGS. 2A-2B) may provide the combined power signal 402, thereby providing enough power to meet the power requirement 408. Furthermore, by combining the power signal 402 and the supplemental power signal 404, a power factor associated with the induction cooktop appliance 200 is approximately one. In this way, a current component of the power signal 404 and a current component of the supplemental power signal 406 may be approximately equal in magnitude.

Referring again to FIGS. 2A-2B, the controller 216 may include one or more processors (not shown) configured to perform operations to control the induction heating system 200. More particularly, the controller 216 may be configured to receive a power request for the inverter 210 that corresponds to the power requirement of the induction heating system 200. For instance, in some embodiments, the controller 216 may receive signals indicative of a power request for the inverter 210 from the control panel 122 (FIG. 1). More particularly, the signals indicative of the power request may be based, at least in part, on user input at the control panel 122 (e.g., via controls 124) (FIG. 1). Furthermore, the power request may correspond to the power requirement of the coil 212. The controller may be further configured to determine whether the power request exceeds a mains power threshold. The mains power threshold may be indicative of a maximum power suppliable by the AC power supply 202.

Furthermore, in response to determining whether the power request exceeds the mains power threshold, the controller 216 may be configured to adjust one or more operating parameters of the battery assembly 220. For instance, in response to determining the power request exceeds the mains power threshold, the controller 216 may configure the battery assembly 220 to supply the supplemental power signal to the inverter 210. In this manner, the inverter 210 may provide a combined power signal to the coil 212 that includes the power signal supplied by the AC power supply 202 and the supplemental power signal supplied by the battery assembly 220. More particularly, in response to receiving the power signal from the AC power supply 202 and the battery assembly 220 (e.g., combined power signal), the inverter 210 may provide a current component of the combined power signal to the coil 212. As such, when the AC power supply 202 is incapable of providing enough power to meet the power request, the controller 216 may configure the battery assembly 220 to provide a supplemental power signal that, when combined with the power signal supplied by the AC power supply 202, meets the power request.

Conversely, in response to determining the mains power threshold exceeds the power request (e.g., the power request does not exceed the mains power threshold), the controller 216 may configure the battery assembly 220 to receive charge from the power supply circuit 204. In this manner, the battery assembly 220 may charge the one or more battery packs 222 when the AC power supply 202 is able to supply enough power to meet the power request.

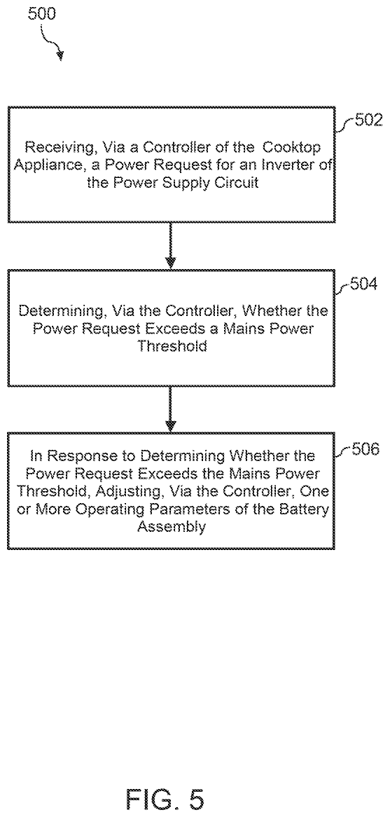

FIG. 5 depicts a flow diagram of an example method 500 for operating a cooktop appliance according to example embodiments of the present disclosure. More particularly, method 500 can be implemented in an induction heating system, such as induction heating system 200, of any suitable cooktop appliance, such as cooktop appliance 100. FIG. 5 depicts steps performed in a particular order for purposes of illustration and discussion. Those of ordinary skill in the art, using the disclosures provided herein, will understand that various steps of any of the methods described herein can be omitted, expanded, performed simultaneously, rearranged, and/or modified in various ways without deviating from the scope of the present disclosure. Furthermore, various steps (not illustrated) can be performed without deviating from the scope of the present disclosure. Additionally, method 500 is generally discussed with reference to the cooktop appliance 100 described above with reference to FIG. 1 and the induction heating system 200 described above with reference to FIGS. 2-4. However, it should be understood that aspects of the present method 500 can find application with any suitable cooktop appliance (e.g., induction cooktop appliance, range appliance, etc.) and induction heating system.

The method 500 may include, at (502), receiving, via a controller of the cooktop appliance, a power request for an inverter of the power supply circuit. More particularly, as discussed above, a cooktop appliance (e.g., cooktop appliance 100) may include an induction heating system (e.g., induction heating system 200). The induction heating element may include an induction heating element (e.g., coil 212) operable to inductively heat a load with a magnetic field using power supplied by a power supply circuit (e.g., power supply circuit 204) that is coupled to an alternating current (AC) power supply (e.g., AC power supply 202). The induction heating system may also include a controller (e.g., controller 216) operably coupled to the power supply circuit that is configured to control operation of the induction heating system based at least in part on a power requirement of the induction heating system. More particularly, the controller may be operably coupled to an inverter (e.g., inverter module 210) of the power supply circuit and may be configured to receive a power request from the inverter. As noted above, the “power requirement” of the induction heating system refers to a total power output required by the induction heating element.

The method 500 may include, at (504), determining, via the controller, whether the power request exceeds a mains power threshold. More particularly, the controller (e.g., controller 216) may determine whether the amount of power requested by the induction heating element exceeds the mains power threshold, which is indicative of a maximum power suppliable by an alternating current (AC) power supply (e.g., AC power supply 202) of the cooktop appliance.

The method 500 may include, at (506), adjusting, via the controller, one or more operating parameters of the battery assembly in response to determining whether the power request exceeds the mains power threshold. More particularly, the controller may be configured to adjust one or more operating parameters of the battery assembly, and the operating parameter(s) adjusted may depend on whether the amount of power requested by the induction heating element exceeds the mains power threshold. For instance, in response to determining the power request exceeds the mains power threshold at (504), the controller may configure the battery assembly to supply a supplemental power signal to the inverter. Conversely, in response to determining the power request does not exceed the mains power threshold (e.g., the mains power threshold exceeds the power requirement) at (504), the controller may configure the battery assembly to receive charge from the power supply circuit for charging one or more battery packs (e.g., battery pack 222) of the battery assembly.

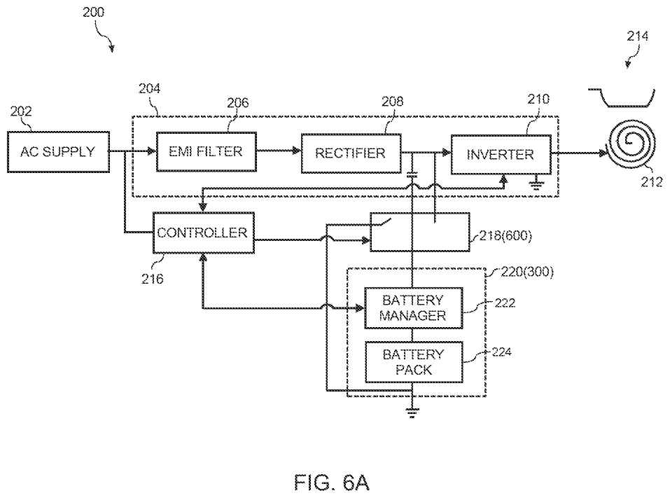

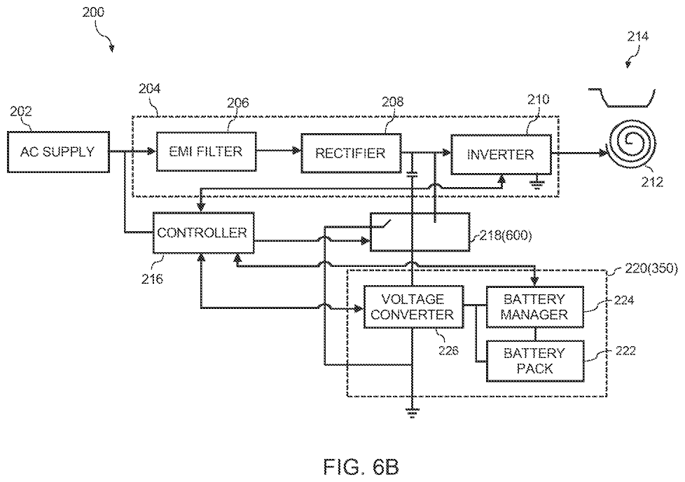

As an illustrative example, FIGS. 6A-6B depict block diagrams of the example induction heating system of FIGS. 2A-2B according to example embodiments of the present disclosure. More particularly, FIG. 6A depicts the induction heating system 200 having the battery assembly 220 with configuration 300 discussed above with reference to FIG. 3A. Similarly, FIG. 6B depicts the induction heating system 200 having the battery assembly 220 with configuration 350 discussed above with reference to FIG. 3B. Although depicted as a relay in FIGS. 6A-6B, it should be noted that switching element 218 may be any suitable switching element, such as a switch, without deviating from the scope of the present disclosure.

As noted above, in response to determining the power request exceeds the mains power threshold at (504) (FIG. 5), the controller 216 may configure the battery assembly 220 to supply a supplemental power signal to the inverter module 210 at (506) (FIG. 5). More particularly, when the switching element 218 (e.g., relay) has pinout 600, the battery assembly 220 may be configured to supply a supplemental power signal from the one or more battery packs 222 to the inverter 210. Furthermore, a magnitude of the supplemental power signal may correspond to a difference between the power request and the mains power threshold. Put differently, the supplemental power signal provides the amount of excess power (e.g., over the mains power threshold) requested by the coil 212. Furthermore, in some embodiments (e.g., FIG. 6B), a bidirectional voltage converter 226 may be configured to adjust the supplemental power signal provided to the inverter 210 based at least in part on the amount of power requested by coil 212. In this way, the minimum power output of the inverter 210 may be reduced, thereby leading to improved low-power performance.

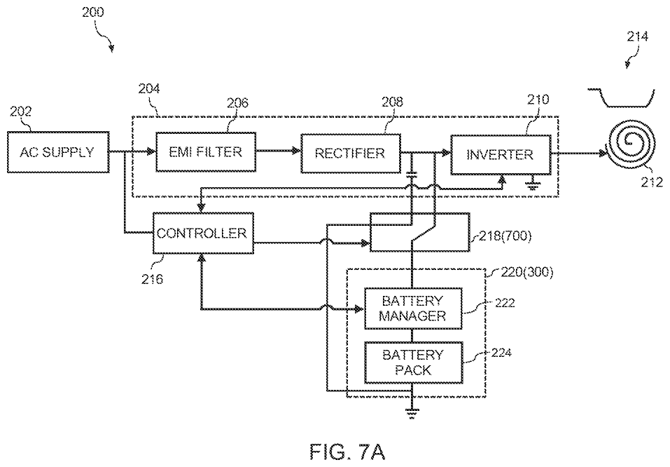

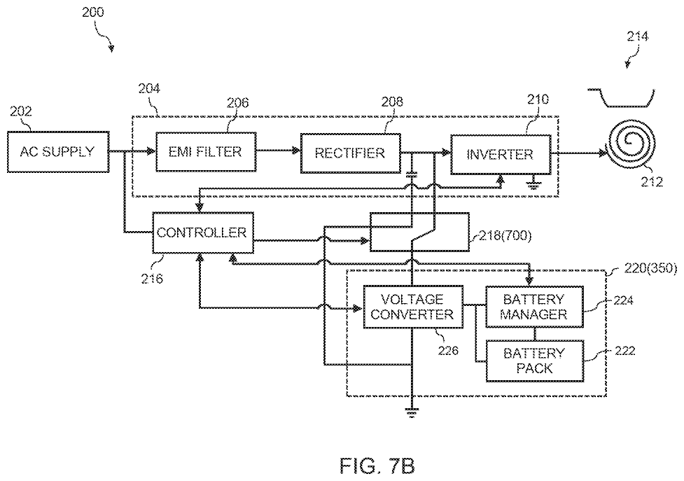

As an additional illustrative example, FIGS. 7A-7B depict block diagrams of the example induction heating system of FIG. 2A according to example embodiments of the present disclosure. More particularly, FIG. 7A depicts the induction heating system 200 discussed above with reference to FIG. 6A, and FIG. 7B depicts the induction heating system 200 discussed above with reference to FIG. 6B. However, in contrast to FIGS. 6A-6B, the switching element 218 depicted in FIGS. 7A-7B has pinout 700.

As noted above, in response to determining the power request does not exceed the mains power threshold at (504) (FIG. 5), the controller 216 may configure the battery assembly 220 to receive charge from the power supply circuit 204 for charging the one or more battery packs 222 of the battery assembly 220 at (506) (FIG. 5). More particularly, when switching element 218 (e.g., relay) has pinout 700, the battery assembly 220 may be configured to receive charge from the power supply circuit 204. Put differently, when the amount of power required by the coil 212 is wholly suppliable by the AC power supply 202, the power supply circuit 204 may provide charge to the battery assembly 220, and the coil 212 may be supplied by the AC power supply 202. In this manner, the one or more battery packs 222 may be charged during operation of the cooktop appliance 100. Furthermore, in situations where the coil 212 is not in use (e.g., not requesting any power), the one or more battery packs 222 may similarly be charged.

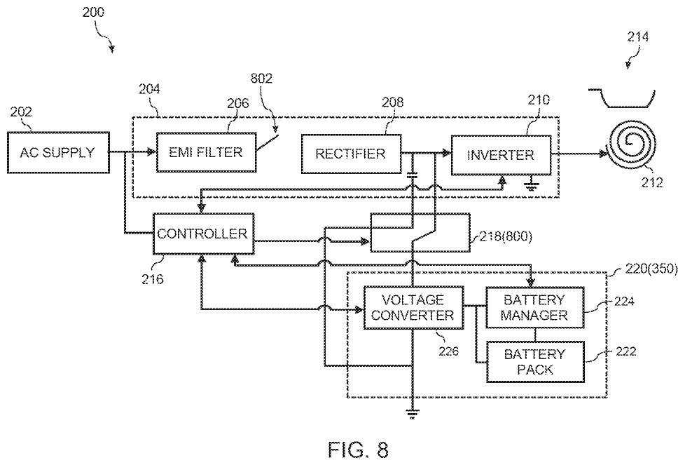

As an additional illustrative example, FIG. 8 depicts a block diagram of the example induction heating system of FIG. 2A according to example embodiments of the present disclosure. More particularly, FIG. 8 depicts the induction heating system 200 discussed above with reference to FIG. 6B and FIG. 7B. However, in contrast to FIG. 6B and FIG. 7B, the AC power supply 202 has been removed (represented by disconnection 802). As such, FIG. 8 depicts a scenario such as, e.g., a power outage. For instance, as shown in FIG. 8, the battery assembly 220 may be configured to provide power to the inverter 210, even when the AC power supply 202 is disconnected (e.g., not providing power signals to the inverter 210). In this manner, example aspects of the present disclosure provide an induction cooktop appliance capable of operation during situations where there is no power provided by the AC power supply 202, such as in a power outage.

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. An induction heating system, comprising:
an induction heating element operable to inductively heat a load with a magnetic field;
a power supply circuit coupled to an alternating current (AC) power supply configured to supply a power signal to the induction heating system, the power supply circuit comprising an inverter;
a battery assembly coupled to the power supply circuit via a switching element, the battery assembly configured to supply a supplemental power signal to the induction heating system; and
a controller operably coupled to the power supply circuit and to the battery assembly, the controller configured to control operation of the induction heating system based at least in part on a power requirement of the induction heating system.

2. The induction heating system of claim 1, wherein the controller is configured to control operation of the induction heating system by performing operations, the operations comprising:
receiving a power request for the inverter, the power request corresponding to the power requirement;
determining whether the power request exceeds a mains power threshold, the mains power threshold being indicative of a maximum power suppliable by the AC power supply;
in response to determining whether the power request exceeds the mains power threshold, adjusting one or more operating parameters of the battery assembly,
wherein the power requirement corresponds to a total power output required by the induction heating element.

3. The induction heating system of claim 2, the operations further comprising:
in response to determining the power request exceeds the mains power threshold, configuring the battery assembly to supply the supplemental power signal to the inverter.

4. The induction heating system of claim 3, wherein the inverter is configured to provide a combined power signal to the induction heating element, the combined power signal comprising the power signal supplied by the AC power supply and the supplemental power signal supplied by the battery assembly.

5. The induction heating system of claim 2, the operations further comprising:
in response to determining the mains power threshold exceeds the power request, configuring the battery assembly to receive charge from the power supply circuit.

6. The induction heating system of claim 1, wherein the power supply circuit further comprises a rectifier circuit coupled to the AC power supply and to the inverter, wherein the rectifier circuit is configured to:
rectify the power signal received from the AC power supply; and
provide a rectified power signal to the inverter.

7. The induction heating system of claim 1, wherein the battery assembly comprises:
one or more battery packs, each battery pack of the one or more battery packs comprising a plurality of battery cells; and
a battery manager coupled to the one or more battery packs and to the controller,
wherein the battery manager is configured to operate the battery assembly based at least in part on control signals received from the controller.

8. The induction heating system of claim 7, wherein the battery assembly further comprises a bidirectional voltage converter coupled to the battery manager and to the controller.

9. The induction heating system of claim 8, wherein the bidirectional voltage converter is configured to:
charge each of the one or more battery packs of the battery assembly;
adjust a total output voltage of the supplemental power signal; and
provide the supplemental power signal to the inverter of the power supply circuit.

10. The induction heating system of claim 9, wherein the bidirectional voltage converter is further configured to adjust the total output voltage of the supplemental power signal to lower a total voltage input at the inverter.

11. The induction heating system of claim 1, wherein the battery assembly is coupled in series with the power supply circuit.

12. The induction heating system of claim 1, wherein a power factor of the induction heating system is approximately one.

13. A method for operating a cooktop appliance comprising a power supply circuit and a battery assembly, the method comprising:
receiving, via a controller of the cooktop appliance, a power request for an inverter of the power supply circuit;
determining, via the controller, whether the power request exceeds a mains power threshold, the mains power threshold being indicative of a maximum power suppliable by an alternating current (AC) power supply of the cooktop appliance;
in response to determining whether the power request exceeds the mains power threshold, adjusting, via the controller, one or more operating parameters of the battery assembly.

14. The method of claim 13, wherein adjusting one or more operating parameters of the battery assembly comprises:
in response to determining the power request exceeds the mains power threshold, configuring, via the controller, the battery assembly to supply a supplemental power signal to the inverter.

15. The method of claim 14, wherein a magnitude of the supplemental power signal corresponds to a difference between the power request and the mains power threshold.

16. The method of claim 13, wherein adjusting one or more operating parameters of the battery assembly comprises:
in response to determining the mains power threshold exceeds the power request, configuring, via the controller, the battery assembly to receive charge from the power supply circuit.

17. A cooktop appliance, comprising:
a user interface comprising a user input;
an induction heating system comprising:
an induction heating element operable to inductively heat a load with a magnetic field;
a power supply circuit coupled to an alternating current (AC) power supply configured to supply a power signal to the induction heating system, the power supply circuit comprising an inverter;
a battery assembly coupled to the power supply circuit via a switching element, the battery assembly configured to provide a supplemental power signal to the induction heating system; and
a controller operably coupled to the power supply circuit and to the battery assembly, the controller configured to control operation of the induction heating system based at least in part on a power requirement of the induction heating system,
wherein the power requirement corresponds to a total power output required by the induction heating element.

18. The cooktop appliance of claim 17, wherein the controller is configured to control operation of the induction heating system by performing operations, the operations comprising:
receiving a power request for the inverter, the power request corresponding to the power requirement;
determining whether the power request exceeds a mains power threshold, the mains power threshold being indicative of a maximum power suppliable by the AC power supply;
in response to determining whether the power request exceeds the mains power threshold, adjusting one or more operating parameters of the battery assembly.

19. The cooktop appliance of claim 18, the operations further comprising:
in response to determining the mains power threshold exceeds the power request, configuring the battery assembly to receive charge from the power supply circuit for charging one or more battery packs of the battery assembly; and
in response to determining the power request exceeds the mains power threshold, configuring the battery assembly to supply the supplemental power signal to the inverter, a magnitude of the supplemental power signal corresponding to a difference between the power request and the mains power threshold.

20. The cooktop appliance of claim 17, wherein the AC power supply is at least one of a 120 VAC power supply, a 208 VAC power supply, a 220 VAC power supply, or a 240 VAC power supply.
